(19) United States
(12) Patent Application Publication
(10) Pub. No.: US 2024/0389679 A1
(43) Pub. Date: Nov. 28, 2024

(54) Biodegradable Smoking Cessation Device

(71) Applicant: Brooke Powell Marshall Black, Sioux Falls, SD (US)

(72) Inventor: Brooke Powell Marshall Black, Sioux Falls, SD (US)

(21) Appl. No.: 18/668,138

(22) Filed: May 18, 2024

Related U.S. Application Data
(60) Provisional application No. 63/469,159, filed on May 26, 2023.

(51) Int. Cl. A24F 47/00; A01C 1/00; A24D 3/04; A24D 3/06; A24D 3/10; A24D 3/17; A24F 42/20; A24F 42/60; A24F 42/80

(52) U.S. Cl. CPC A24F 47/00; A01C 1/00; A24D 3/04; A24D 3/068; A24D 3/10; A24D 3/17; A24F 42/20; A24F 42/60; A24F 42/80

(57) ABSTRACT

A smoking cessation device is disclosed. A biodegradable smoking cessation device is designed to aid in curbing cigarette smoking addiction and address the environmental harms posed by cigarettes. The device comprises a biodegradable reed casing, seed, filters, and food-grade adhesive. Composed of biodegradable materials, this device allows a seed to move in the body of the tube, in between the two filters, when the user inhales. The biodegradable filters are permeable to air flow, and function to stop the seed from escaping the tube. The seed travels upwards and downwards, scarifying the surface of the seed and creating friction which mimics the sensation of smoking a cigarette. After use, the user can break the tube and plant, eat, or discard the seed. This is an environmentally friendly, non-smoking related hobby that has been scientifically shown to reduce stress, anxiety, and depression.

### PRIORITY CLAIM/INCORPORATION BY REFERENCE

This application claims priority to the U.S. Provisional Application Ser. No. 63/469,159, filed on May 26, 2023 and entitled “A seed in a bamboo straw for use in smoking cessation,” the entirety of which is incorporated herein by reference.

### BACKGROUND OF THE INVENTION

Breaking the addiction to smoking is a major concern for those using tobacco cigarettes or other smoking cessation devices currently on the market. According to the Centers for Disease Control (CDC), smoking kills around 480,000 Americans every year. Quitting smoking is challenging on a psychological, as well as a chemical level; even when a smoker wishes to quit, the addictive qualities of the act lead to very low success rates. On average, people try to quit 30 or more times before succeeding. The problem isn't just chemical. Nicotine withdrawal generally subsides after 3-4 weeks. Many products exist for nicotine addictions, including gums and patches, however, these solutions do not address the comfort or habit of the physical act of smoking, yet quitters using these alternative products report feelings of anxiety and stress, as well as feelings of missing having something to do with their hands and mouths.

Pollution from smoking and smoking cessation devices is also a major concern. When a tobacco cigarette is lit, it releases carbon monoxide into the atmosphere. The tobacco smoke inhaled by the smoker is carcinogenic and toxic to the user and to those around them. With typical cigarettes, once a smoker is done with their cigarette, what is left is frequently tossed on the ground, resulting in litter and pollution to the earth. The World Health Organization (WHO) estimates that 4.5 trillion cigarette butts pollute the environment every year. Currently, non-tobacco smoking mechanisms on the market, including electronic smoking cessation, rechargeable devices that come with a variety of flavors (“Vape Juices”), as well as other non-tobacco smoking devices currently on the market present multiple issues pertaining to the environment, users' physical health, and the smoking epidemic as the devices are not entirely chemical-free, holistic approaches to breaking the smoking addiction.

Other products include plastic or wooden vaporless inhalers, including those that utilize essential oils soaked into a polyester core, are not biodegradable and only address cravings without offering other activities to mitigate the overall stress/anxiety caused by quitting smoking. Most vaporless inhalers fail to offer any benefits beyond simulating cigarette smoking, both for the user and for the environment. This epidemic has caused major health concerns, particularly in youth demographics, and places a higher demand on the market for a more sustainable, healthy solution to the systemic problem.

Another major drawback to existing smoking cessation devices on the marketplace is the negative environmental effects of aerosol-generating substrate formed by a homogenized plant material. Many electronic smoking devices which use non-tobacco plant particles emit toxins into the environment and the user's body, by creating greenhouse gases and cancer-causing chemicals into the users' lungs. These alternative non-tobacco smoking cessation devices fail to offer benefits beyond simulating cigarette smoking, both for the user and for the environment.

The present invention seeks to address the need in the marketplace for a non-carcinogenic, non-tobacco smoking cessation product market that is not damaging to the user or environment, unlike other alternatives which may contain tar or carbon monoxide. These harmful chemicals are similarly found in tobacco cigarettes, the product by which the smoking cessation devices were designed to replace. Efficient smoking cessation devices must be able to feed the habit of smoking without exposing the user to the same toxic chemicals of tobacco cigarettes. By reproducing the same toxic chemicals, many alternative smoking cessation devices do not address the problem created by cigarette smoking but replace it with an equally damaging one.

Herbal smokes and herbal cigarettes have existed in the market since the early 1960s and 1970s. Each of these respective devices contain synthetic flavors such as marshmallow leaves, red clover flowers, rose petals, fruit juices, honey, Virginia flavor, raspberry, mullein, and chamomile. However, one of the biggest downfalls to these inventions is that they still contain tar, carbon-monoxide, or other dangerous, toxic substances that jeopardize the environment and the users' health.

Another smoking cessation device currently on the market is electronically charged cigarettes, or “e-cigarettes.” Electronically charged cigarettes contain vaporized juices that the user inhales, potentially consisting of tobacco and other equally harmful toxins with negative health effects such as creating a plastic lining in the user's lungs over time. Further, unlike other tobacco cigarette substitutes, electronically charged cigarettes typically are made from and emit toxic chemicals harmful to the environment, the user, and the users' surroundings. For individuals who smoke who are looking for an alternative way to curb this addiction, electronically charged cigarettes pose similar risks regarding addiction, health and environmental effects, restrictions on no smoking or vaping in buildings, and forced designated areas to use these products.

Even existing biodegradable smoking cessation devices currently on the market pose risks to their consumers. Existing biodegradable smoking cessation devices typically involve a non-biodegradable, aerosol provision system harmful to the body and the environment, thus failing to address the problems created by tobacco cigarettes.

There is a need for a clean, cost-effective, therapeutic alternative to tobacco cigarettes and the smoking cessation devices currently on the market. There is an especially prevalent need for a product that is completely biodegradable, to limit or eliminate the predominant pollutants and environmentally damaging waste caused by cigarettes and other devices. Additionally, there is a need for a cost-effective, multifaceted smoking cessation device made for consumers in the U.S. and worldwide.

### SUMMARY OF THE INVENTION

The present invention provides a novel biodegradable smoking cessation device that eliminates the inhalation of toxic materials while also promoting environmental sustainability and aiding in smoking cessation through the psychologically therapeutic hobby of gardening. Users place one end of the device to their mouth and inhale through it as they would with a traditional cigarette. During inhalation, a plant seed secured within the device travels within the length of a reed straw, creating friction that simulates drawing on a cigarette. Concurrently, repeated friction of the plant seed against the inner casing of the reed straw scratches, softens, or otherwise weakens the seed exterior, known in horticulture as the process of scarification. After use for 2-4 hours a day for 1-3 days, thereafter, the user may snap the device with ease to subsequently release and plant the scarified seed, whereby the weakened seed exterior promotes germination and facilitates the absorption of water and nutrients. By planting and cultivating the seed, the user can tap into the mentally therapeutic aspects of gardening. As the device is made from biodegradable materials, Seed Straws can additionally be composted.

The device comprises a biodegradable tube, a minimum of one plant seed, a food-grade adhesive, and two biodegradable filters.

Exemplary embodiments describe a smoking cessation device wherein the biodegradable tube has a length of 88.9 mm-100 mm with an external diameter of no more than 8 mm and an internal diameter of no less than 4 mm. The biodegradable tube is comprised of biodegradable materials, including reed straws, bamboo straws, agave straws, coba straws, or other similar plant-based material. The biodegradable filters, composed of unbleached paper, are cylindrical and range in length from 3 mm to 9 mm; the diameter of the biodegradable filters ranges from 4 mm to 8 mm, enabling the biodegradable filters to fit within the biodegradable tube, depending on the inner diameter of that tube. In an optimal embodiment, the diameter of the filters is the same as the diameter of the tube. A first filter is positioned on the first end of the biodegradable tube and a second filter is positioned on the opposite second end of the biodegradable tube. The set of biodegradable filters consists of two and each filter is preamble to airflow. Thus, when the user inhales or exhales on the tube, air flows through each filter. The interior seed can move freely inside the biodegradable tube, between the two filters, and will move with the airflow created by the suction or inhalation by the user. The 73 mm distance between the two filters is ideal to maximize the friction and drag sensation created by the seed in between the two filters. The smoking cessation device can be snapped at any time between 1-3 days to retrieve the seed inside, and it can be planted. The food-grade adhesive materials are comprised of food-grade adhesive including pine resin or beeswax, and wherein said food-grade adhesive materials secure the filters in place against the inner wall of the biodegradable tube. The user may inhale on the device. When the user inhales on the device, the seed between the filter creates friction. The friction of the user's inhalation scratches, softens, or otherwise weakens the seed exterior, simplifying the germination and planting process after use, as water and nutrients can more easily be absorbed. In one embodiment, the interior of the device where the seed is housed is intentionally roughened so that scarification increases.

In another aspect of the exemplary embodiments, there is provided a method of assembling a biodegradable smoking cessation device comprising the steps of cutting a biodegradable tube, inserting at least one planting seed into said biodegradable tube, cutting at least two biodegradable filters, applying at least two applications of food-grade adhesive materials onto the exterior of said biodegradable filters, and wedging said biodegradable filters into opposite ends of said biodegradable tube. A thin layer of food-grade adhesive is applied using a paintbrush. Initially, the biodegradable tube is cut using a hot wire foam cutter or hot knife at a 90 degree angle at a length of 88.9 mm-100 mm resulting in a first section at incision with the opposite end being a second section and where the first and second sections have an exterior diameter of no more than 8 mm and an internal diameter of no less than 4 mm, whereby said tube is comprised of biodegradable materials, including reed straws, bamboo straws, agave straws, coba straws, or other similar plant-based material. Then, the plant seed is inserted into the biodegradable tube, whereby the plant seed is circular and has a diameter of no more than 7.8 mm. Next, the biodegradable filters are cut to a length ranging from 3 mm to 9 mm and a diameter ranging from 7.5 mm to 8 mm, whereby the biodegradable filters are comprised of biodegradable, unbleached paper materials. The unbleached paper may be pre-manufactured with a paper weight of 60-80 lb so that it can withstand user inhalation, but may still be malleable. Subsequently, the food-grade adhesive materials are applied along the exterior of the biodegradable filters. The food-grade adhesive materials are comprised of food-grade adhesive, including pine resin or beeswax. These food-grade adhesives are purchased. The food-grade adhesive is melted using a wax warmer. Then, using a paintbrush (brush style: filbert size 9 or around 7-8), a thin layer is applied to the interior of the biodegradable tube in a circular motion. Each biodegradable filter is slipped halfway into the tube. If a gap between the filter and the inner wall of the tube remains, a layer is added to the exterior of the filter, and it is pressed the rest of the way in. The food-grade adhesive is allowed to cool and solidify, and any excess on the interior of the straw is poked out using a scratch awl. The seed is then inserted. The process is repeated on the other side, with the other filter. If excess food-grade adhesive forms on the inside of the straw, it is pulled out using the rounded point of the scratch awl. Finally, any excess food-grade adhesive on the outside is scrapped away using a small scraper tool.

In one embodiment, the biodegradable tube has a length of no less than 88.9 mm to most accurately simulate the length of a traditional sized cigarette and to allow the seed adequate room to move freely throughout said tube and aid in the scarification process. In another embodiment, the biodegradable tube has a length of no more than 100 mm to most accurately simulate the length of a traditional 100 mm cigarette and to allow the seed additional room to move freely throughout said tube and aid in the scarification process. Thus, any biodegradable tube with a length less than 88.9 mm, or a length greater than 100 mm is not optimal for the purposes of the disclosed smoking cessation device. In some embodiments, the biodegradable tube is comprised of plant-based material with varying thickness thereby producing varying external and internal diameter sizes. In one embodiment, the biodegradable tube is comprised of reed straw with an external diameter of no more than 8 mm and an internal diameter of no less than 6 mm. In another embodiment, the biodegradable tube is comprised of bamboo straw with an external diameter of no more than 8 mm and an internal diameter of no less than 7 mm. In another embodiment, the biodegradable tube is comprised of agave straw with an external diameter of no more than 8 mm and an internal diameter of no less than 6 mm. In another embodiment, the biodegradable tube is comprised of coba straw with an external diameter of no more than 8 mm and an internal diameter of no less than 4 mm.

A preferred embodiment describes a smoking cessation device comprising a hollow tube wherein the tube is biodegradable, lightweight, and handheld. Two filters are inside the tube, and the filters are attached to the tube by a food-grade adhesive. Each filter is at the end of the tube, opposite to the other filter; the two filters are permeable to airflow. There is a space interior to the tube between the two filters and at least one seed is situated between the two filters. The interior seed can move freely between the two filters. The hollow tube is comprised of reed materials and is 88.9 mm-100 mm long. The food-grade adhesive attaching the filters to the device is comprised of beeswax in one embodiment and pine resin in other embodiments. The user may inhale on the device and, when the user inhales on the device, the seed between the filters creates friction. The friction created by inhalation scarifies the interior seed which will help the seed germinate upon planting.

One aspect of the present disclosure is directed to a smoking cessation device comprising: a biodegradable tube; at least one seed; a food-grade adhesive; and a set of biodegradable filters. In one embodiment, the biodegradable tube has a length of 88.9 mm-100 mm with an external diameter of no more than 8 mm and an internal diameter of no less than 4 mm. In another embodiment, the biodegradable filters have a length of 3-5 mm and a diameter of 7.5-7.9 mm, enabling said filters to fit within the biodegradable tube, and wherein the first filter is positioned on the anterior end of the biodegradable tube, and wherein the second filter is positioned on the opposite posterior end of the biodegradable tube. In one embodiment, the biodegradable tube is comprised of biodegradable materials, including reed straws, bamboo straws, agave straws, coba straws, or other similar plant-based material. In one embodiment, the set of biodegradable filters consist of two filters, and are preamble to airflow.

In one embodiment, the seed can move freely between the two filters. In another embodiment, the about 73 mm distance between the two filters is ideal to maximize the friction and drag sensation created by the seed in between the two filters. In one embodiment, the finished smoking cessation device is capable of being snapped, to retrieve the seed or seed inside for optional planting of the seed such that the seed can then germinate. In another embodiment, the food-grade adhesive materials are comprised of food-grade adhesive, including pine resin or beeswax, and wherein said food-grade adhesive materials secure the filters in place against the inner wall of the biodegradable tube. In one embodiment, the user may inhale on the device and when the user inhales on the device the seed between the filter creates friction, wherein the friction of the user's inhalation scarifies the seed simplifying the germination and planting process after use; and wherein the interior of the device where the seed is house is intentionally roughened so that scarification increases.

Another aspect of the present disclosure is directed to a method of assembling a biodegradable smoking cessation device comprising the steps of cutting a biodegradable tube; inserting at least one planting seed into said biodegradable tube; cutting at least two biodegradable filters; applying at least two applications of food-grade adhesive materials onto the exterior of said biodegradable filters; and wedging said biodegradable filters into opposite ends of said biodegradable tube.

In one embodiment, the biodegradable tube is cut to a length of no less than 88.9 mm-100 mm with an external diameter of no more than 8 mm and an internal diameter of no less than 4 mm and is comprised of biodegradable materials, including reed straws, bamboo straws, agave straws, coba straws, or other similar plant-based material. In another embodiment, the plant seed is inserted into the biodegradable tube whereby the plant seed is circular and has a diameter of no more than about 8 mm. In one embodiment, the biodegradable filters are cut to a length of 3 mm to 9 mm and a diameter of 7.5-8 mm, and whereby the biodegradable filters are comprised of biodegradable materials, including reed straw or other similar plant-based material.

In one embodiment, the food-grade adhesive materials are applied along the exterior of the biodegradable filters and whereby the food-grade adhesive materials are comprised of biodegradable materials, including pine resin or beeswax. In another embodiment, one biodegradable filter, loaded with food-grade adhesive material along its exterior, is wedged into the anterior end of the biodegradable tube and against said tube's anterior inner walls, and wherein a second biodegradable filter, loaded with food-grade adhesive material along its exterior, is wedged into the posterior end of the biodegradable tube and against said tube's posterior inner walls.

Another aspect of the present disclosure is directed to a smoking cessation device comprising: (a) a hollow tube wherein the tube is biodegradable, lightweight, and handheld; (b) two filters, wherein said filters are inside the tube, are attached to the tube by a food-grade adhesive, and wherein each filter is at the end of the tube, opposite to the other and the filters are permeable to airflow; (c) an interior space within the tube, between the two filters; (d) at least one seed situated in between the two filters; and wherein the at least one seed can move freely between the two filters. In one embodiment, the hollow tube is comprised of reed materials and is about 88.9 mm-100 mm long. In another embodiment, the food-grade adhesive attaching the filters to the device is comprised of beeswax or pine resin. In one embodiment, when the user of the device inhales on the device, the seed between the filters moves inside the hollow tube and the friction caused by this movement mimics a cigarette draw and scarifies the seed to help in its germination once planted.

### BRIEF SUMMARY OF DRAWINGS

FIG. 1. shows a right-side perspective view of a smoking cessation device according to an exemplary embodiment.

FIG. 2. shows a right-side perspective view of a smoking cessation device wherein portions are transparent to illustrate two filters inserted into a hollow cylindrical tube, secured by food-grade adhesive materials, and a plant seed with space to move freely between said filters according to an exemplary embodiment.

FIG. 3. shows an angled side view of a smoking cessation device, wherein portions are transparent to illustrate the placement of the biodegradable filters to be wedged into the hollow cylindrical tube and the space in which the plant seed may move freely between said filters according to an exemplary embodiment.

FIG. 4. shows an angled side view of a smoking cessation device, wherein portions are transparent to illustrate the hollow nature of the cylindrical tube and space in which the plant seed can move freely within said hollow cylindrical tube between the secured biodegradable filters according to an exemplary embodiment.

FIG. 5. shows a front or rear perspective view of a smoking cessation device, showing a biodegradable filter inserted into one end according to an exemplary embodiment.

FIG. 6. shows an exploded view of the biodegradable filter to illustrate the application of food-grade adhesive onto the exterior of said biodegradable filter according to an exemplary embodiment.

FIG. 7. shows a superior view of the biodegradable smoking cessation device to illustrate the biodegradable smoking cessation device once a user snaps it in half to release the plant seed in preparation for planting according to an exemplary embodiment.

### DETAILED DESCRIPTION

The exemplary embodiments describe a smoking imitation device for the cessation of smoking that is composed of biodegradable materials to aid smokers in their efforts to quit smoking. In addition to its biodegradable and eco-friendly qualities, the invention described herein may benefit the environment by planting a seed when the user is done with the product. Such embodiments will become more fully understood from the following detailed description, taken in conjunction with the accompanying figures, wherein like reference numerals refer to like elements.

The term “some” as used herein is to be understood as “none or one or more than one or all.” Accordingly, the terms, “none,” “one” “more than one,” “more than one, but not all” or “all” would fall under the definition of “some.” The term “some embodiments” may refer to no embodiments or to all embodiments, without departing from the scope of the present disclosure. The terminology and structure employed herein is for describing, teaching, and illuminating some embodiments and their specific features. It does not in any way limit, restrict or reduce the spirit and scope of the claims or their equivalents. More specifically, any terms used herein such as but not limited to “includes,” “comprises,” “has,” “consists,” and grammatical variants thereof do not specify an exact limitation or restriction, and certainly do not exclude the possible addition of one or more features or elements, unless otherwise stated, and furthermore must not be taken to exclude the possible removal of one or more of the listed features and elements, unless otherwise stated with the limiting language “must comprise” or “need to include.”

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfill the requirements of uniqueness, utility and non-obviousness.

Before any embodiments of the invention are explained in detail, it is to be understood that the disclosure is not limited in its application to the details of construction nor to the arrangement of components set forth in the following description or illustrated in the drawings. The disclosure is capable of other embodiments and of being practiced or of being carried out in various ways.

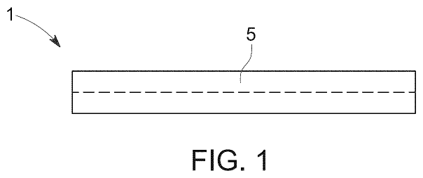

FIG. 1 shows a side perspective view of an exemplary biodegradable smoking cessation device 1. It should be understood that FIG. 1 shows an exterior view of the biodegradable tube 5 as it would appear to a user. The exemplary biodegradable smoking cessation device 1 comprises a biodegradable tube 5. In the example of FIG. 1., the biodegradable smoking cessation device 1 is shown in an exterior position viewed by a user.

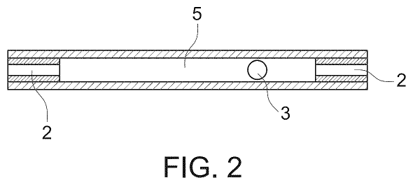

FIG. 2 shows a cross-sectional view of an exemplary biodegradable smoking cessation device 1 according to various exemplary embodiments. In the example of FIG. 2, the biodegradable tube 5 is shown as being transparent to show the various exemplary components that may be included in the biodegradable tube 5. Within the biodegradable tube 5 sits two filters 2, secured at each end, and a plant seed 3 situated in the interior of the biodegradable tube 5. As will be described in greater detail below, a plant seed 3 may move freely between the two filters 2 in an up-and-down motion upon inhalation and exhalation. The optimal dimensions of said tube 5 may range between 88.9 mm to 100 mm in length with an external diameter of no more than 8 mm and an internal diameter of no less than 4 mm which mimic the range of sizes of traditional cigarettes. Additionally, the biodegradable tube 5 is composed of a reed straw to provide users with a somatic sensation akin to the weight and feel of a traditional cigarette. Moreover, biodegradable materials like a reed straw contain low snap resistance, allowing users to break the biodegradable smoking cessation device 1 and release the plant seed 3 without undue physical exertion. Those skilled in the art will understand that a reed straw can be replaced with other biodegradable materials of similar snap resistance.

FIG. 2 additionally shows the relative size and placements of the filter 2 components housed within the biodegradable tube 5. Specifically, the two filters 2 are 3 mm to 9 mm in length and 7.5 mm to 8 mm in diameter and are inserted into said biodegradable tube 5, with both filters sitting in the interior of the tube at opposite outer ends. Each filter 2 is permeable to airflow. In some embodiments, a barrier, also permeable to air flow, may be attached to each filter to keep the seed within the tube. Additionally, each filter 2 is composed of biodegradable materials, such as unbleached paper, and is secured in place using food-grade adhesive material 4, such as, but not limited to, pine resin or beeswax.

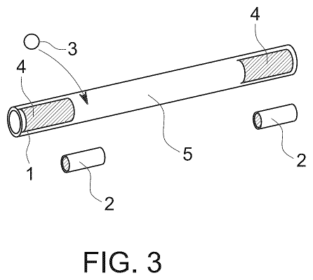

FIG. 3 shows an exploded cross-sectional view of an exemplary biodegradable smoking cessation device 1 according to various exemplary embodiments. It should be understood that FIG. 3 shows the biodegradable smoking cessation device 1 prior to assembly in which the filters 2 and plant seed 3 are not yet inserted into the biodegradable tube 5. The shaded areas of FIG. 3 indicate the optimal placements of the food-grade adhesive material 4, including, but not limited to, pine resin or beeswax, to secure the filters 2 in place.

FIG. 3 additionally illustrates the upper and lower spatial limits of plant seed 3 in relation to the filters 2. A user inhales through the opening of the biodegradable tube 5, causing the plant seed 3 to move towards the user, thus providing tactile feedback simulating the sensation of the draw of a traditional cigarette. Repeated inhalation of the biodegradable smoking cessation device 1 promotes scarification of said plant seed 3 as inhalation causes friction between the plant seed 3 and the inner wall of the biodegradable tube 5. In other exemplary embodiments, the inner wall of the biodegradable tube 5 may be jagged or otherwise roughened using mesh or similar roughening material to further promote the scarification of the plant seed 3.

The plant seed 3 is circular, with a diameter of no more than 7.9 mm, to appropriately fit into the 8 mm diameter of the biodegradable tube 5 and move freely between the filters 2. In other exemplary embodiments, the seed 3 may be one seed and may be of varying sizes of no more than about 7 mm. The seed 3 may be of a variety native to a user's local flora in furtherance of the claimed invention's additional purpose of promoting a sustainable, eco-friendly hobby.

The biodegradable tube 5 is composed of biodegradable materials. In some embodiments, a reed straw is optimal, due to its relatively low snap resistance and similar weight and texture to a traditional cigarette. Other embodiments may replace reed straw with other similar plant-based materials in consideration of their snap resistance, weight, and texture, including, but not limited to bamboo straws, agave straws, or coba straws. After use, approximately 1-3 days, the plant seed 3 is adequately scarified from the friction created by inhalation by the user. At this stage, a user may snap the biodegradable smoking cessation device 1 open, without undue physical exertion, thereby releasing the plant seed 3, exposing the plant seed 3 to sunlight, and germination upon planting. Users may provide the plant seed 3 with appropriate conditions, such as soil and water, to promote the germination and subsequent growth process. Additionally, due to the materials of the biodegradable smoking cessation device 1, the remaining snapped device 1 may be used for composting.

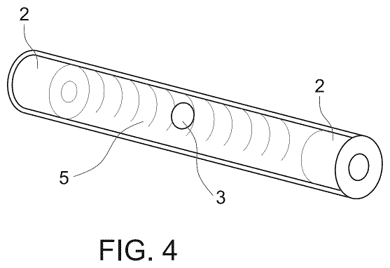

FIG. 4 is a side perspective of the biodegradable smoking cessation device 1, focusing on the movement of the seed 3 inside of the straw 5, according to one embodiment. In one embodiment, the two biodegradable filters 2 are located at each end of the straw 5. The two filters 2 are set in place at each end by food-grade adhesive 4. The food-grade adhesive 4 is made from beeswax. The composition of the filters 2 and food-grade adhesive 4 allows for them to be biodegradable as well as the straw 5. The distance between the two filters 2 is 73 mm (about 2.88 in). The space in between the filters 2 allows for the plant seed 3 to move back and forth. In one embodiment, this movement of the seed 3 aids in the process of scarification. The outside of the seed 3 is scarred, which helps with germination. The filters 2 are positioned at each end to allow for the maximum amount of distance to be traveled by the seed 3. The motion of the seed 3 is limited to right and left.

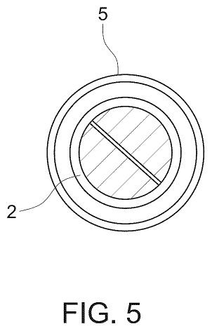

FIG. 5 is an enlarged side view of one biodegradable filter 2, according to one embodiment disclosed. In one embodiment the filters 2 are 3-9 mm in length and 7.5-8 mm in diameter. Each filter 2 is placed at the mouth of each end of the biodegradable hollow straw tube 5. The filter 2 allows for air flow to pass through the tubing as the user inhales. Moreover, it prevents the seed 3 from being inhaled by the user. In some embodiments, the prevention of inhalation is aided by a barrier, permeable to airflow, attached to the filters. This inhalation by the user mimics that of a traditional cigarette.

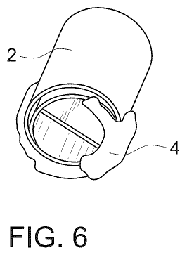

FIG. 6 is an exploded view of the biodegradable filter 2, according to one embodiment disclosed. In one embodiment, the filter 2 is placed inside the straw 5 at the end of the hollow straw tube 5. The filter 3 is set in place by food-grade adhesive 4. The food-grade adhesive 4 is made from beeswax and is spread all along the outside of the biodegradable filter 2. The thin coat of beeswax applied to the outside of the filter 2 does not obstruct the air flow as the user inhales.

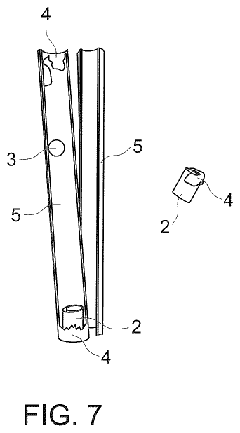

FIG. 7 is a superior view of the biodegradable smoking cessation device 1 with each piece visible, according to one embodiment disclosed. In one embodiment, biodegradable tube 5 comprises of two filters 2, food-grade adhesive 4, and plant seed 3. The biodegradable tube 5 is made of reed. The optimal dimensions for the biodegradable tube 5 are no less than 88.9 mm and no more than 100 mm in length and no more than 8 mm in diameter which mimic that of a traditional cigarette. In one embodiment, the biodegradable tube 5 is cut at the optimal length using a hot wire foam cutter or hot knife at a 90-degree angle, resulting in a first section at the point of incision and where the opposite end of the tube 5 results in a second section. In some embodiments, the process of cutting the tube 5 produces a jagged edge of the first section whereby the jagged first section is rubbed against the broad end of a hot knife blade to smooth out the jagged edge. In one embodiment, there are two biodegradable filters 2, which are placed at both ends of the hollow straw tube 5. Each filter 2 is 3-9 mm in length and 7.5-8 mm in diameter and is composed of biodegradable, unbleached paper. In one embodiment, food-grade adhesive 4 is coated around the outside of each filter 2 to make sure the filters 2 are set in place at the ends of the hollow straw tube 5. The food-grade adhesive 4 is made from beeswax. In one embodiment, the plant seed 3 is able to move in between the filters 2. This movement aids in the process of scarification. As the seed 3 moves back and forth, the outside of the seed 3 is gently scarred, which prepares it for germination.

It will be apparent to those skilled in the art that various modifications may be made in the present disclosure without departing from the spirit or the scope of the disclosure. Thus, it is intended that the present disclosure covers modifications and variations of this disclosure provided they come within the scope of the appended claims and their equivalent.

What is claimed:

1. A smoking cessation device comprising:
a. a biodegradable tube; and
b. at least one seed; and
c. a food-grade adhesive; and
d. a set of biodegradable filters.

2. The smoking cessation device of claim 1, wherein the biodegradable tube has a length of 88.9 mm-100 mm with an exterior diameter of no more than 8 mm and an internal diameter of no less than 4 mm.

3. The smoking cessation device of claim 1, wherein the biodegradable filters have a length of 3-8 mm and a diameter of 7.5-8 mm, enabling said filters to fit within the biodegradable tube, and
wherein one filter is positioned on one end of the biodegradable hollow cylindrical tube, and
wherein the second filter is positioned on the opposite end of the biodegradable tube, and
the filters are composed of unbleached paper.

4. The smoking cessation device of claim 1, wherein the biodegradable tube is comprised of biodegradable materials, including reed straws, bamboo straws, agave straws, coba straws, or other similar plant-based material.

5. The smoking cessation device of claim 1, wherein the set of biodegradable filters consists of two filters, and wherein said filters allow the flow of air through them based on a person inhaling on said smoking cessation device.

6. The smoking cessation device of claim 1, wherein the seed can move freely between the two filters.

7. The smoking cessation device of claim 1, wherein the about 73 mm (about 2.88 in) distance between the two filters is ideal to maximize the friction and drag sensation created by the seed in between the two filters.

8. The smoking cessation device of claim 1, wherein the finished smoking cessation device is snappable at a point along its length, in order to retrieve the seed inside for planting or germination.

9. The smoking cessation device of claim 1, wherein the food-grade adhesive materials are comprised of food-grade adhesive including pine resin or beeswax, and wherein said food-grade adhesive materials secure the filters in place against the inner wall of the biodegradable tube.

10. The smoking cessation device of claim 1, wherein the user may inhale on the device; and when the user inhales on the device, the seed between the filter creates friction, wherein the friction that is created by the seed moving back and forth between the filters due to the user's inhalation, scarifies the seed and thereby assist in the germination process after the seed is planted; and
wherein the interior of the biodegradable tube where the seed is housed is intentionally roughed so that scarification increases.

11. A method of assembling a biodegradable smoking cessation device, comprising:
a. cutting a biodegradable tube resulting in a first section on one end and a second section on the opposite end;
b. inserting at least one planting seed into the first section of said biodegradable tube;
c. providing at least two cylindrical biodegradable filters;
d. applying at least two applications of food-grade adhesive materials onto the exterior of said biodegradable filters; and
e. wedging said biodegradable filters into the first section and second section of said biodegradable tube.

12. The method of claim 11, wherein the biodegradable tube is hollow and cut at a 90-degree angle at a length of 88.9 mm-100 mm resulting in a first section at the point of incision with the opposite end being a second section and where the first and second sections have an exterior diameter of no more than 8 mm and an interior diameter of no less than 4 mm and is comprised of biodegradable materials, including reed straws, bamboo straws, agave straws, coba straws, or other similar plant-based material.

13. The method of claim 11, wherein the plant seed is inserted into the biodegradable tube and whereby the plant seed is circular and has a diameter of no more than about 7.8 mm.

14. The method of claim 11, wherein the biodegradable filters are cut to a length of 3-9 mm and a diameter of 7.5-8 mm, and
whereby the biodegradable filters are comprised of biodegradable materials, including unbleached paper; wherein the unbleached paper is premade and cut to the optimal length.

15. The method of claim 11, wherein the food-grade adhesive materials are thinly applied along the exterior of the biodegradable filters and whereby the food-grade adhesive materials are comprised of biodegradable materials, including pine resin or beeswax.

16. The method of claim 11, wherein the food-grade adhesive is melted using a wax warmer, a thin layer is applied via a paintbrush to the interior of the biodegradable tube in a circular motion, and the filter is slipped halfway into the tube, whereby if a gap between the filter and the inner wall of the tube remains, a thin layer is added to the exterior of the filter, and it is pressed the rest of the way in and the food-grade adhesive is allowed to cool and solidify, and any excess on the interior of the tube is poked out using a scratch awl, and then a seed is inserted and the process is repeated on the other side of the tube with the other filter, and if excess food-grade adhesive forms on the inside of the straw, it is pulled out using the rounded point of the scratch awl and finally any excess food-grade adhesive on the outside is scrapped away using a small scraper tool.

17. A smoking cessation device comprising:
a. a hollow tube wherein the tube is biodegradable, lightweight, and handheld;
b. two filters, wherein said filters are inside the tube; are attached to the tube by a food-grade adhesive, and further wherein each filter is at the end of the tube, opposite to the other and the filters are permeable to airflow;
c. an interior space within the tube, between the two filters;
d. at least one seed situated in between the two filters; and wherein
e. at least one seed can move freely between the two filters.

18. The smoking cessation device of claim 17 wherein the hollow tube is comprised of reed materials and is 88.9 mm-100 mm long.

19. The smoking cessation device of claim 17, wherein the food-grade adhesive attaching the filters to the device is comprised of beeswax or pine resin.

20. The smoking cessation device of claim 17, wherein when the user of the device inhales on the device, the seed inside the hollow tube that is between the filters moves to create a friction and said friction caused by this movement mimics a cigarette draw and also scarifies the seed to help in its germination once planted.
